(19) United States
(12) Patent Application Publication
(10) Pub. No.: US 2006/0153449 A1
(43) Pub. Date: Jul. 13, 2006

(54) Block-based parallel image thinning methods, computer program products and systems

(75) Inventors: Deok-soo Park, Seoul (KR); Dong-jae Lee, Seoul (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/241,620

(22) Filed: Sep. 30, 2005

(30) Foreign Application Priority Data
Jan. 11, 2005 (KR) 10-2005-0002463

(51) Int. Cl. G06K 9/34

(52) U.S. Cl. 382/173

(57) ABSTRACT

A block-based parallel image thinning method segments an input image into blocks, determines the block flag of each of the segmented blocks, and determines a preservation condition of an object pixel of a corresponding block. Then, the method determines a removal condition of the object pixel for which the preservation condition has been determined, removes the value of the object pixel satisfying the removal condition and sets the block flag. When all the blocks have been thinned, the method thins the processed image into one-pixel thickness using a post processing condition. Related systems and computer program products also are provided.

### CROSS-REFERENCE TO RELATED PATENT APPLICATION

This application claims the benefit under 35 USC § 119 of Korean Patent Application No. 10-2005-0002463, filed on Jan. 11, 2005, the disclosure of which is incorporated herein by reference in its entirety.

### FIELD OF THE INVENTION

The present invention relates to digital image processing, and more particularly, to image thinning methods, systems and computer program products-.

### BACKGROUND OF THE INVENTION

Digital image thinning is used for character recognition, fingerprint recognition, inspection of defects of circuit boards and/or many other applications. Thinning is designed to extract the skeleton of an image from an input image composed of a lot of bit information in order to reduce the quantity of calculations while maintaining characteristics of the image. Image thinning should satisfy the following basic conditions:

Firstly, the thinning result should have a thickness corresponding to one pixel.

Secondly, the thinning result should be located at the center of the original image.

Thirdly, connectivity of the original image should be maintained.

Fourthly, the length of the original image should not be continuously decreased.

Fifthly, noise or unevenness of the original image should not affect the thinning result.

Image thinning can be classified into a pixel-based thinning and thinning that does not process images based on pixels. The latter directly detects the skeleton from an image and may generate larger noise than the former. The pixel-based thinning can be robust against noise but may consume a long processing time.

The pixel-based thinning may be divided into sequential thinning and parallel thinning. The sequential thinning may be difficult to construct because pixel removal may be affected by the results of all the previous pixel removal processes. The parallel thinning may be relatively easy to construct because previous processing steps need not be considered in an iterative processing step. However, it may be difficult to maintain connectivity of the original image. Accordingly, the parallel thinning should consider not only eight neighborhood pixels of a pixel (3×3) but also eight neighborhood pixels of eight pixels (24×24) or reproduce removed pixels in order to maintain connectivity. This may lengthen processing time.

Therefore, thinning capable of reducing processing time while satisfying the above-described basic conditions of thinning is desired.

### SUMMARY OF THE INVENTION

According to exemplary embodiments of the present invention, there is provided an image thinning method including: (a) segmenting an input image into blocks; (b) determining a block flag of each of the segmented blocks; (c) determining a preservation condition of an object pixel of a corresponding block; (d) determining a removal condition of the object pixel for which the preservation condition has been determined; (e) removing the value of the object pixel satisfying the removal condition and setting the block flag; (f) determining whether all the blocks have been thinned and, when blocks to be thinned are left, iterating from (b) through (e); and (g) processing the image obtained in (f) into one-pixel thickness using a post processing condition. Related computer program products also may be provided.

In some embodiments of the present invention, the preservation condition includes horizontal, vertical and diagonal directions based on the object pixel.

The condition of horizontal direction is set when a 1×4 window pattern including the object pixel P corresponds to 0-P-1-0, and the condition of vertical direction is set when a 4×1 window pattern including the object pixel P corresponds to 0-P-1-0. The condition of diagonal direction is set when eight neighborhood pixels p2, p3, p4, p5, p6, p7, p8 and p9 of a 3×3 window pattern including the object pixel P at the center thereof, which are arranged clockwise starting from the position above the object pixel, correspond to 0-0-0-0-0-0-1-1, 1-0-0-0-0-0-0-1 or 0-1-0-1-0-1-0-1.

In exemplary embodiments of the present invention, the preservation condition is set when B(p)=1, B(p)=2 to 6 and A(p)>1, or B(p)=8 which is defined based on the number of black pixels, B(p), among eight neighborhood pixels surrounding the object pixel and the number of cases, A(p), where a pixel value 0 is changed to 1 when the values of the eight neighborhood pixels are checked clockwise.

In exemplary embodiments of the present invention, the removal condition is set when B(p)=2 to 6 and A(p)>1 which is defined based on the number of black pixels B(p) among the eight neighborhood pixels surrounding the object pixel P and the number of cases, A(p), where a pixel value 0 is changed in 1 when the values of the eight neighborhood pixels are checked clockwise or when eight neighborhood pixels p2, p3, p4, p5, p6, p7, p8 and p9 of a 3×3 window pattern including the object pixel P at the center thereof, which are arranged clockwise starting from the position above the object pixel, correspond to 0-1-0-1-0-1-0-1.

In exemplary embodiments of the present invention, the post processing condition is set when eight neighborhood pixels p2, p3, p4, p5, p6, p7, p8 and p9 of a 3×3 window pattern including the object pixel P at the center thereof, which are arranged clockwise starting from the position above the object pixel, correspond to x-0-x-x-1x-1-x (where x is don't care) or 1-x-x-0-x x-1-x (where x is don't care).

According to other embodiments of the present invention, there is provided an image thinning system including a block segmentation unit, a thinning unit, and a post processing unit. The block segmentation unit is configured to receive an input image and to segment the image into blocks based on a kind of the image. The thinning unit is configured to thin the segmented blocks in parallel. The post processing unit is configured to process an output of the thinning unit into one-pixel thickness. Related computer program products also may be provided.

Accordingly, thinning methods, systems and computer program products according to exemplary embodiments of the present invention can enable rapid processing because the image is segmented into blocks, each having a predetermined size and processed in parallel. Furthermore, the potential problem of two-pixel thickness can be solved by post processing. A thinned image processed according to embodiments of the present invention can maintain connectivity without losing information and can be similar to the connection of central lines of the original image. In addition, the thinned image can maintain the shape of the original image. Embodiments of the present invention can be used for character recognition, fingerprint recognition, video information compression and/or many other applications of thinning.

### BRIEF DESCRIPTION OF THE DRAWINGS

FIGS. 1 A and 1B are diagrams for explaining four and eight neighborhood pixels according to exemplary embodiments of the invention;

FIGS. 2A through 2D are diagrams for explaining a condition of preservation according to exemplary embodiments of the present invention;

FIGS. 3A and 3B are diagrams for explaining a condition of removal according to exemplary embodiments of the present invention;

FIGS. 4A through 4D are diagrams for explaining a case of maintaining a thickness corresponding to two pixels according to exemplary embodiments of the present invention;

FIGS. 5A and 5B are diagrams for explaining a post-processing condition according to exemplary embodiments of the present invention;

FIG. 6 is a diagram for explaining a data region having a size of (N+3)×(N+3), which is used for thinning a block having a size of N×N according to exemplary embodiments of the present invention;

FIG. 7 is a flow chart for explaining thinning according to exemplary embodiments of the present invention; and

FIG. 8 is a block diagram of thinning according to exemplary embodiments of the present invention.

### DETAILED DESCRIPTION OF THE INVENTION

The present invention now will be described more fully hereinafter with reference to the accompanying drawings, in which illustrative embodiments of the invention are shown. However, this invention may be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “coupled”, “connected” or “responsive” to another element, it can be directly coupled, connected or responsive to the other element or intervening elements may also be present. In contrast, when an element is referred to as being “directly coupled”, “directly connected” or “directly responsive” to another element, there are no intervening elements present. Like numbers refer to like elements throughout. As used herein the term “and/or” includes any and all combinations of one or more of the associated listed items and may be abbreviated by “/”.

It also will be understood that, as used herein, the terms “horizontal” and “vertical” indicate two relative non-parallel directions that may be orthogonal to one another. However, these terms do not require an absolute horizontal or vertical orientation as shown in the figures.

It will also be understood that, although the terms first, second, etc. may be used herein to describe various elements, these elements should not be limited by these terms. These terms are only used to distinguish one element from another element.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention is described in part below with reference to block diagrams and flowcharts of methods, systems and computer program products according to embodiments of the invention. It will be understood that a block of the block diagrams or flowcharts, and combinations of blocks in the block diagrams or flowcharts, may be implemented at least in part by computer program instructions. These computer program instructions may be provided to one or more enterprise, application, personal, pervasive and/or embedded computer systems, such that the instructions, which execute via the computer system(s) create means, modules, devices or methods for implementing the functions/acts specified in the block diagram block or blocks. Combinations of general purpose computer systems and/or special purpose hardware also may be used in other embodiments.

These computer program instructions may also be stored in memory of the computer system(s) that can direct the computer system(s) to function in a particular manner, such that the instructions stored in the memory produce an article of manufacture including computer-readable program code which implements the functions/acts specified in block or blocks. The computer program instructions may also be loaded into the computer system(s) to cause a series of operational steps to be performed by the computer system(s) to produce a computer implemented process such that the instructions which execute on the processor provide steps for implementing the functions/acts specified in the block or blocks. Accordingly, a given block or blocks of the block diagrams and/or flowcharts provides support for methods, computer program products and/or systems (structural and/or means-plus-function).

It should also be noted that in some alternate implementations, the functions/acts noted in the flowcharts may occur out of the order noted in the flowcharts. For example, two blocks shown in succession may in fact be executed substantially concurrently or the blocks may sometimes be executed in the reverse order, depending upon the functionality/acts involved. Finally, the functionality of one or more blocks may be separated and/or combined with that of other blocks.

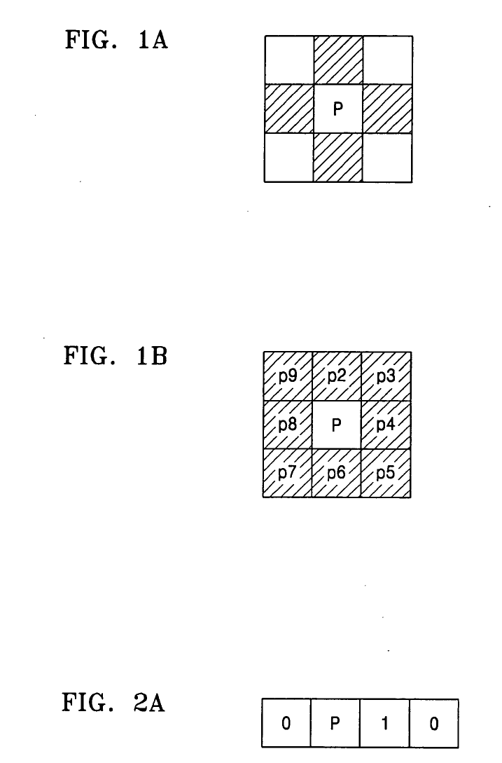

FIGS. 1 A and B are diagrams for explaining four and eight neighborhood pixels according to exemplary embodiments of the present invention. Referring to FIG. 1A, four neighborhood pixels vertically and horizontally adjacent to an object pixel P are defined. Referring to FIG. 1B, eight neighborhood pixels p2, p3, p4, p5, p6, p7, p8 and p9 surrounding an object pixel P are defined. An input image is a binary image and is divided into black pixels and white pixels. Gray scale input images may be converted to binary using thresholding and/or other known techniques. The black pixels compose an object and have a pixel value “1” while the white pixels construct a background and have a pixel value “0”. The black pixels become the object of removal or preservation. The number of black pixels, B(p), which surround the object pixel P, is defined as follows:

$$B ( p ) = {\sum }_{n = 2}^{9} {p}_{n} \qquad [ Equation 1 ]$$

The number of cases, A(p), where the pixel value 0 is changed to 1 when the values of the eight neighborhood pixels surrounding the object pixel P are checked clockwise is defined as follows:

$$A ( p ) = ( {\sum }_{n = 2}^{9} \vert {p}_{n} - {p}_{n + 1} \vert ) / 2 \qquad [ Equation 2 ]$$

Thinning according to exemplary embodiments of the present invention is divided into pixel-based removal/preservation, post-processing and block-based processing.

1. Pixel-Based Removal/Preservation

The object pixel P is determined by searching the image vertically and horizontally. Here, a pixel having a pixel value “1”, that is, a pixel constructing an object, becomes the object pixel. When the object pixel P is determined, a condition of preservation is applied to the object pixel P. To satisfy the condition of preservation, the object pixel P does not lose connectivity. The condition of preservation corresponds to vertical, horizontal and diagonal pixels having a 2-pixel thickness. The condition of preservation makes the object pixel maintain connectivity even if the object pixel is processed into a pixel having the 2-pixel thickness.

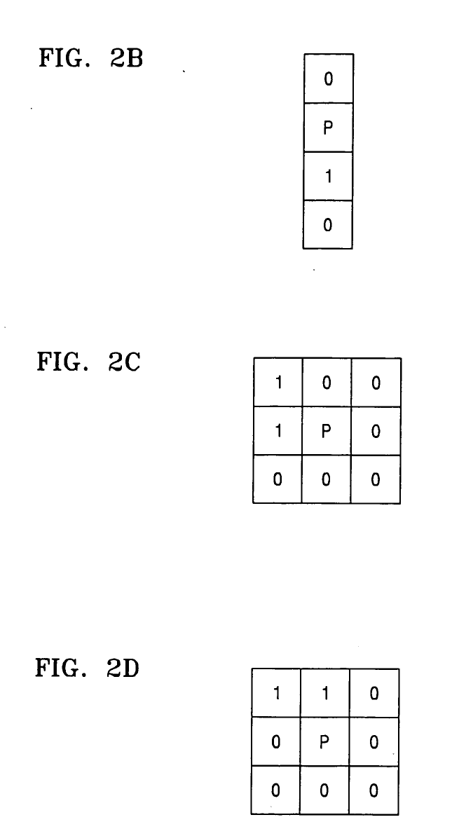

FIGS. 2A through 2D are diagrams for explaining a condition of preservation according to exemplary embodiments of the present invention. FIG. 2A shows the condition of horizontality. Referring to FIG. 2A, the condition of preservation is set when a 1×4 window pattern including the object pixel P corresponds to 0-P-1-0. FIG. 2B shows the condition of verticality. Referring to FIG. 2B, the condition of preservation is set when a 4×1 window pattern including the object pixel P corresponds to 0-P-1-0. FIGS. 2C and 2D show the condition of diagonality. Referring to FIGS. 2C and 2D, the condition of preservation is set when eight neighborhood pixels p2, p3, p4, p5, p6, p7, p8 and p9 arranged clockwise starting from the position above the object pixel P are 0-0-0-0-0-0-1-1 or 1-0-0-0-0-0-0-1. These conditions can maintain connectivity of pixels and can prevent and/or reduce disappearance of an end point, which may occur in the thinning. The pixels preserved in the 2-pixel thickness are modified into pixels having a 1-pixel thickness in the post processing.

The condition of removal is applied to the object pixel that does not satisfy the condition of preservation. The condition of removal removes outer pixels while maintaining connectivity. The condition of removal can require only eight neighborhood pixels surrounding the object pixel. The condition of removal may be defined using the above-described A(p) and B(p). When the number of black pixels, B(p), among the eight neighborhood pixels is 1, which means that the object pixel P is an end point, the object pixel is not removed. When B(p)=8, the object pixel is not an outer pixel and thus it is excepted from the object of removal.

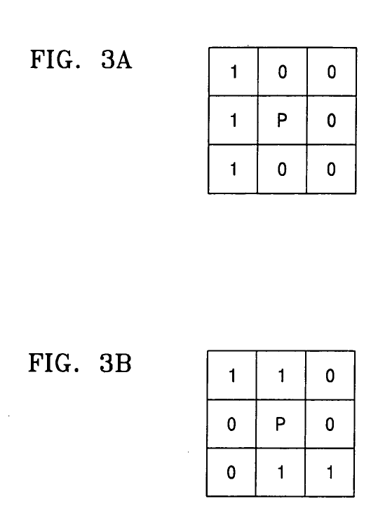

When the number of black pixels surrounding the object pixel, B(p), is between 2 and 7, it should be determined whether the object pixel P is a connection pixel or an outer pixel. Here, the object pixel P corresponds to the connection pixel when B(p) is between 2 and 6 and A(p) is larger than 2. In this case, connectivity may be a problem when the object pixel is removed. Accordingly, the object pixel is removed when B(p) is between 2 and 6 and A(p) is equal to 1. When B(p)=7, the condition of removal is determined based on the position of one white pixel among the eight neighborhood pixels. The object pixel is removed when the position of the white pixel corresponds to 4 neighborhood pixels but preserved when it corresponds to p8. This is because the skeleton of the object should have connection of the 8 neighborhood pixels and the background should have connection of the 4 neighborhood pixels. FIGS. 3A and 3B show examples of the condition of removal.

The aforementioned pixel-based removal/preservation conditions are arranged as shown in Table 1.

TABLE 1

| B(p) | A(p) | Preservation/removal | Remarks |
|---|---|---|---|
| 1 | X | Preservation | End point |
| 2 to 6 | 1 | Removal | Contour |
| | >1 | Preservation | Connecting point |
| 7 | X | Determine by position of ‘0’ | ‘0’: 4 neighborhood |
| | | | pixels (removal) |
| 8 | x | Preservation | Candidate of skeleton |

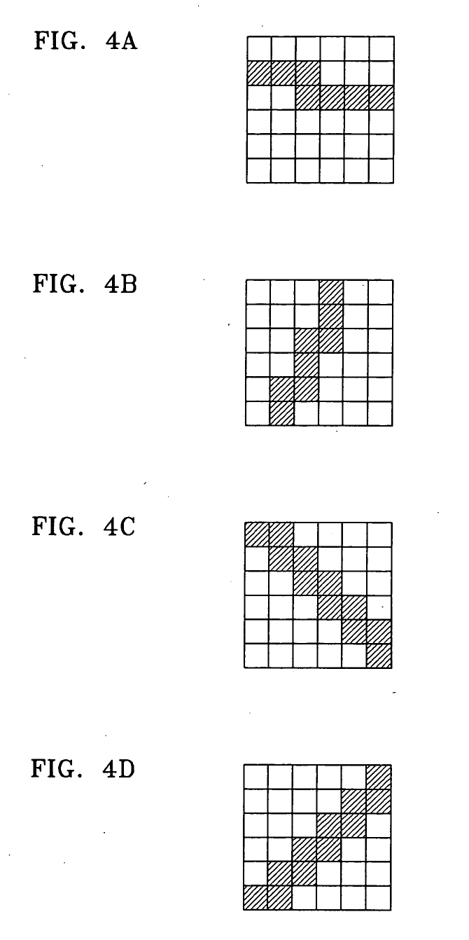

The removal/preservation conditions as represented by Table 1 can enable thinning while maintaining the connectivity of image. However, cases of maintaining a thickness corresponding to two pixels in the horizontal direction of FIG. 4A, vertical direction of FIG. 4B and diagonal directions of FIGS. 4C and 4D may be generated. Post processing can address these cases.

2. Post Processing

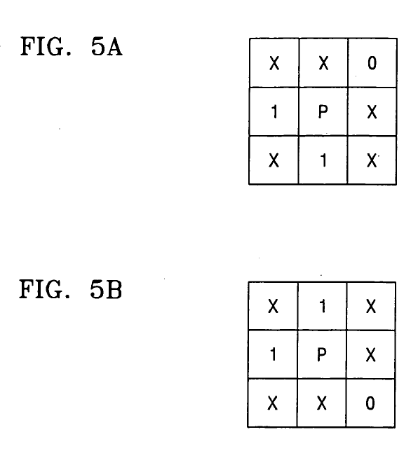

The image that has passed the removal/preservation conditions may have vertical, horizontal and diagonal pixels having a thickness corresponding to two pixels. Accordingly, one-time post processing may be carried out in order to satisfy one-pixel thickness that is a basic condition for thinning. This is realized by removing the position of a pixel that simultaneously has connection of the neighborhood pixels p4 and p8. FIGS. 5A and 5B show two conditions for the post processing. The post processing condition shown in FIG. 5A is set when the pixel p3 has a value “0”, the pixels p6 and p8 have a value “1”, and the other pixels are “x” (don't care) when P is the object pixel. The post processing condition of FIG. 5B is established when the pixels p1 and p8 have a value “1” and the other pixels are “x” (don't care). The skeleton of the image can be thinned into one-pixel thickness while maintaining connectivity of the neighborhood pixel p8 through the one-time post processing using the aforementioned two conditions.

3. Block-Based Processing

The image is segmented into blocks each have a size of N×N and processed based on characteristics of the image. Each of the blocks has a flag in response to existence or absence of a pixel to be processed. That is, the flag has a value “0” (FALSE) when the block has no pixel to be processed but has a value “1” (TRUE) when the block has a pixel to be processed. The iterative processing of the thinning checks the flag of the block in advance, processes the pixel when the flag is “1”, and skips the block when the flag is “0”. This block-based operation can effectively reduce iteration to shorten processing time.

The block size in the block processing can depend on the kind of image. In the case of recognition of characters on a background, for example, the percentage of the object to be recognized in the entire image is generally very low and thus a large block size may be used. In the case of a fingerprint image, the ratio of the fingerprint to the entire image may be approximately 1:1 and the object to be recognized is a continuous contour line. Thus, the thickness of the contour line of the fingerprint may be appropriate for the block size.

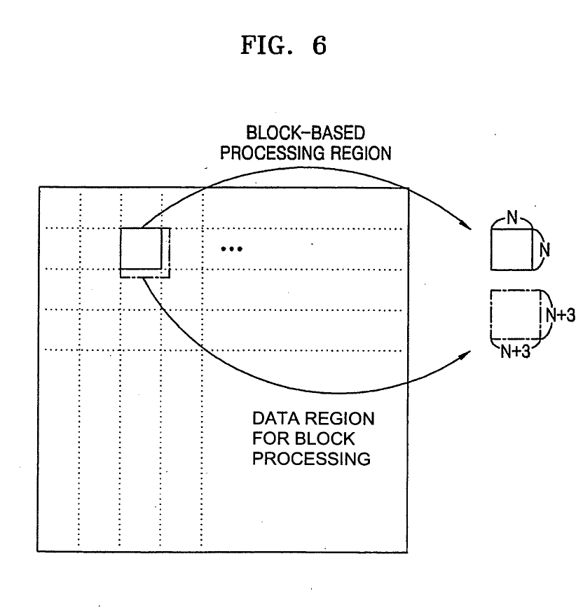

Block-based processing according to exemplary embodiments of the invention can be used for realizing a thinning system. The block-based processing can enable a parallel thinning system irrespective of the size of the entire image. For example, when a block having a size of N×N is independently processed, as shown in FIG. 6, a data region for thinning while reducing blocking effect is (N+3)×(N+3) and the thinning result is N×N, which enables thinning.

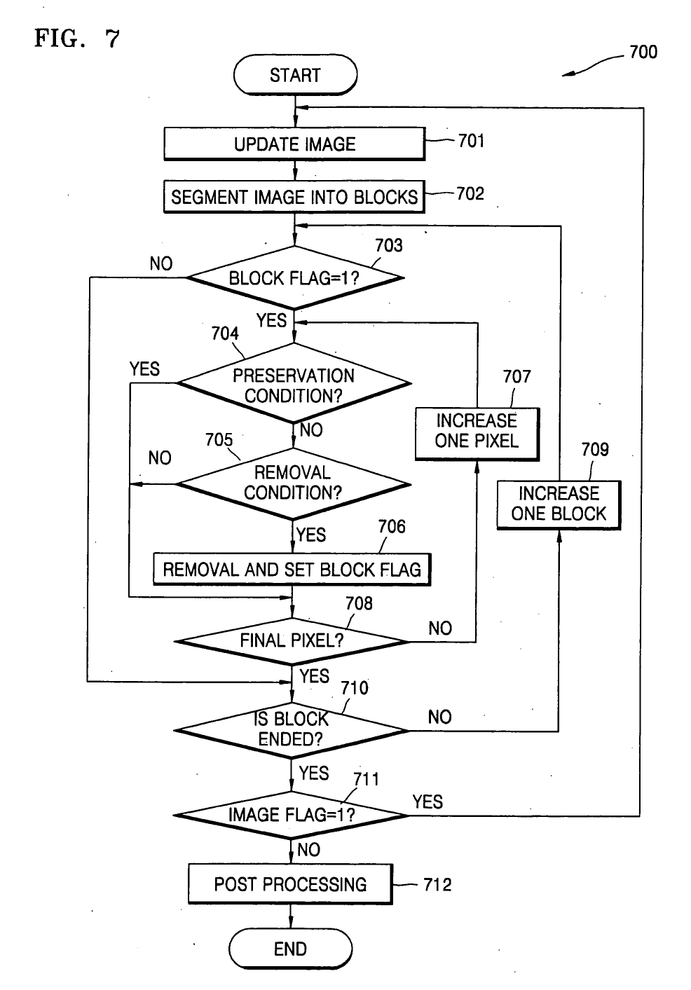

FIG. 7 is a flow chart of operations that can be performed to provide thinning 700 according to exemplary embodiments of the invention, using the aforementioned pixel-based removal/preservation, post processing and block processing according to exemplary embodiments of the present invention. Referring to FIG. 7, the thinning 700 receives an input image and updates the received image in Block 701. Then, the thinning segments the image into blocks based on the kind of the image in Block 702. The thinning determines whether each of the blocks has a pixel to be processed in Block 703. When the flag of the block is “1,”, it is determined whether an object pixel in the block will be preserved or not in Block 704. When the object pixel does not satisfy the preservation condition, it is determined whether the object pixel will be removed or not in Block 705. When the object pixel satisfies the removal condition, the object pixel is removed and the block flag is set in Block 706. Then, it is determined whether all the pixels in the corresponding block have been thinned in Block 708. When the object pixel does not satisfy the preservation condition or removal condition, it is determined whether the object pixel is the last pixel in the corresponding block in Block 708.

When the object pixel is not the final pixel, the number of object pixels is increased by 1 in Block 707 and Blocks 704, 705 and 706 are iterated. When it is determined that all the pixels in the corresponding block have been processed in Block 708, it is judged whether all the blocks have been thinned in Block 710. When a block to be thinned is left, the number of blocks is increased by 1 in Block 709, a determination is made whether a pixel to be processed is left in the block in Block 703, and Blocks 704, 705 and 706 are iterated. When it is determined that all the blocks have been thinned in Block 710, a test is made as to whether the corresponding image flag has been set in Block 711. The next input image is received and the aforementioned blocks are iterated when the image flag has been set to “1” and post processing 712 is carried out when the image flag has been set to “0”.

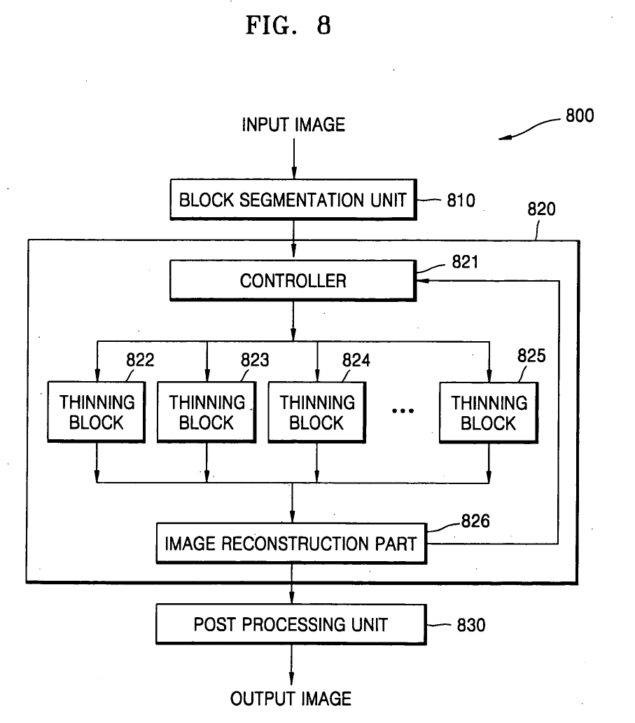

FIG. 8 is a block diagram of a thinning system 800 that can execute the thinning operation of FIG. 7 according to exemplary embodiments of the present invention. Referring to FIG. 8, the thinning system 800 includes a block segmentation unit 810 that is configured to receive an input image and to segment the image into blocks in response to a kind of the image, a thinning unit 820 that is configured to thin the segmented blocks in parallel, and a post processing unit 830 that is configured to process the output of the thinning unit 820 into one-pixel thickness to generate an output image.

The thinning unit 820 includes a controller 821 that is configured to distribute segmented blocks to be processed in response to whether the blocks have block flags or not, thinning blocks 822 through 825 that are configured to thin the distributed blocks in parallel, and an image reconstruction part 826 that is configured to reconstruct an image from the images processed by the thinning blocks 822 through 825 to determine whether the image has been thinned or not. The thinning blocks 822 through 825 are configured to carry out preservation and removal of object pixels for all the pixels in the corresponding blocks and set the block flags.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. An image thinning method comprising:
(a) segmenting an input image into blocks;
(b) determining a block flag of each of the segmented blocks;
(c) determining a preservation condition of an object pixel of a corresponding block;
(d) determining a removal condition of the object pixel for which the preservation condition has been determined;
(e) removing the value of the object pixel satisfying the removal condition and setting the block flag;
(f) determining whether all the blocks have been thinned and, when blocks to be thinned are left, iterating from (b) through (e); and
(g) processing the image obtained in (f) into one-pixel thickness using a post processing condition.

2. The thinning method of claim 1, further comprising determining an image flag of the thinned image,
wherein a next input image is updated in response to the image flag and then (a) through (g) are iterated.

3. The thinning method of claim 1, wherein the preservation condition includes horizontal, vertical and diagonal directions based on the object pixel.

4. The thinning method of claim 3, wherein the condition of horizontal direction is set when a 1×4 window pattern including the object pixel P corresponds to 0-P-1-0.

5. The thinning method of claim 3, wherein the condition of vertical direction is set when a 4×1 window pattern including the object pixel P corresponds to 0-P-1-0.

6. The thinning method of claim 3, wherein the condition of diagonal direction is set when eight neighborhood pixels p2, p3, p4, p5, p6, p7, p8 and p9 of a 3×3 window pattern including the object pixel P at the center thereof, which are arranged clockwise starting from the position above the object pixel, correspond to 0-0-0-0-0-0-1-1.

7. The thinning method of claim 3, wherein the condition of diagonal direction is set when eight neighborhood pixels p2, p3, p4, p5, p6, p7, p8 and p9 of a 3×3 window pattern including the object pixel P at the center thereof, which are arranged clockwise starting from the position above the object pixel, correspond to 1-0-0-0-0-0-0-1.

8. The thinning method of claim 1, wherein the preservation condition includes B(p)=1 which is defined based on the number of black pixels, B(p), among eight neighborhood pixels surrounding the object pixel and the number of cases, A(p), where a pixel value 0 is changed to 1 when the values of the eight neighborhood pixels are checked clockwise.

9. The thinning method of claim 1, wherein the preservation condition includes B(p)=2 to 6 and A(p)>1 which is defined based on the number of black pixels B(p) among the eight neighborhood pixels surrounding the object pixel P and the number of cases, A(p), where a pixel value 0 is changed to 1 when the values of the eight neighborhood pixels are checked clockwise.

10. The thinning method of claim 1, wherein the preservation condition includes B(p)=8 which is defined based on the number of black pixels B(p) among the eight neighborhood pixels surrounding the object pixel P and the number of cases, A(p), where a pixel value 0 is changed to 1 when the values of the eight neighborhood pixels are checked clockwise.

11. The thinning method of claim 1, wherein the preservation condition is set when eight neighborhood pixels p2, p3, p4, p5, p6, p7, p8 and p9 of a 3×3 window pattern including the object pixel P at the center thereof, which are arranged clockwise starting from the position above the object pixel, correspond to 0-1-0-1-0-1-0-1.

12. The thinning method of claim 1, wherein the removal condition includes B(p)=2 to 6 and A(p)>1 which is defined based on the number of black pixels B(p) among the eight neighborhood pixels surrounding the object pixel P and the number of cases, A(p), where a pixel value 0 is changed in 1 when the values of the eight neighborhood pixels are checked clockwise.

13. The thinning method of claim 1, wherein the removal condition is set when eight neighborhood pixels p2, p3, p4, p5, p6, p7, p8 and p9 of a 3×3 window pattern including the object pixel P at the center thereof, which are arranged clockwise starting from the position above the object pixel, correspond to 0-1-0-1-0-1-0-1.

14. The thinning method of claim 1, wherein the post processing condition is set when eight neighborhood pixels p2, p3, p4, p5, p6, p7, p8 and p9 of a 3×3 window pattern including the object pixel P at the center thereof, which are arranged clockwise starting from the position above the object pixel, correspond to x-0-x-x-1x-1-x (where x is don't care).

15. The thinning method of claim 1, wherein the post processing condition is set when eight neighborhood pixels p2, p3, p4, p5, p6, p7, p8 and p9 of a 3×3 window pattern including the object pixel P at the center thereof, which are arranged clockwise starting from the position above the object pixel, correspond to 1-x-x-0-x x-1-x (where x is don't care).

16. The thinning method of claim 1, wherein a data region for thinning has a size of (N+3)×(N+3) when the image is segmented into blocks each have a size of N×N.

17. A computer program product for thinning an image, the computer program product comprising computer program code embodied in a computer-readable medium, the computer program code configured to provide the image thinning method of claim 1.

18. An image thinning system comprising:
a block segmentation unit that is configured to receive an input image and to segment the image into blocks based on a kind of the image;
a thinning unit that is configured to thin the segmented blocks in parallel; and
a post processing unit that is configured to process an output of the thinning unit into one-pixel thickness.

19. The thinning system of claim 18, wherein the thinning unit comprises:
a controller that is configured to distribute blocks to be processed in response to block flags of the segmented blocks;
a plurality of thinning blocks that are configured to thin the distributed blocks in parallel; and
an image reconstructing part that is configured to reconstruct an image from the images processed by the thinning blocks to determine whether the image has been thinned.

20. The thinning system of claim 19, wherein each of the thinning blocks carries out preservation, removal and post-processing of an object pixel for the pixels in a corresponding block.

21. The thinning system of claim 20, wherein the preservation preserves data of the object pixel in response to whether three conditions of horizontal, vertical and diagonal directions based on the object pixel are satisfied.

22. The thinning system of claim 21, wherein the horizontal direction of the preservation condition is set when a 1×4 window pattern including the object pixel P corresponds to 0-P-1-0.

23. The thinning system of claim 21, wherein the vertical direction of the preservation condition is set when a 4×1 window pattern including the object pixel P corresponds to 0-P-1-0.

24. The thinning system of claim 21, wherein the diagonal direction of the preservation condition is set when eight neighborhood pixels p2, p3, p4, p5, p6, p7, p8 and p9 of a 3×3 window pattern including the object pixel P at the center thereof, which are arranged clockwise starting from the position above the object pixel, correspond to 0-0-0-0-0-0-1-1.

25. The thinning system of claim 21, wherein the diagonal direction of the preservation condition is set when eight neighborhood pixels p2, p3, p4, p5, p6, p7, p8 and p9 of a 3×3 window pattern including the object pixel P at the center thereof, which are arranged clockwise starting from the position above the object pixel, correspond to 1-0-0-0-0-0-0-1.

26. The thinning system of claim 20, wherein the preservation preserves the data of the object pixel when B(p)=1 which is defined based on the number of black pixels, B(p), among eight neighborhood pixels surrounding the object pixel and the number of cases, A(p), where a pixel value 0 is changed to 1 when the values of the eight neighborhood pixels are checked clockwise.

27. The thinning system of claim 20, wherein the preservation preserves the data of the object pixel when B(p)=2 to 6 and A(p)>1 which is defined based on the number of black pixels B(p) among the eight neighborhood pixels surrounding the object pixel P and the number of cases, A(p), where a pixel value 0 is changed to 1 when the values of the eight neighborhood pixels are checked clockwise.

28. The thinning system of claim 20, wherein the preservation preserves the data of the object pixel when B(p)=8 which is defined based on the number of black pixels B(p) among the eight neighborhood pixels surrounding the object pixel P and the number of cases, A(p), where a pixel value 0 is changed to 1 when the values of the eight neighborhood pixels are checked clockwise.

29. The thinning system of claim 20, wherein the preservation preserves the data of the object pixel when eight neighborhood pixels p2, p3, p4, p5, p6, p7, p8 and p9 of a 3×3 window pattern including the object pixel P at the center thereof, which are arranged clockwise starting from the position above the object pixel, correspond to 0-1-0-1-0-1-0-1.

30. The thinning system of claim 20, wherein the removal removes the data of the object pixel when B(p)=2 to 6 and A(p)>1 which is defined based on the number of black pixels B(p) among the eight neighborhood pixels surrounding the object pixel P and the number of cases, A(p), where a pixel value 0 is changed in 1 when the values of the eight neighborhood pixels are checked clockwise.

31. The thinning system of claim 20, wherein the removal removes the data of the object pixel when eight neighborhood pixels p2, p3, p4, p5, p6, p7, p8 and p9 of a 3×3 window pattern including the object pixel P at the center thereof, which are arranged clockwise starting from the position above the object pixel, correspond to 0-1-0-1-0-1-0-1.

32. The thinning system of claim 20, wherein the post processing thins two-pixel thickness of the object pixel into one-pixel thickness when eight neighborhood pixels p2, p3, p4, p5, p6, p7, p8 and p9 of a 3×3 window pattern including the object pixel P at the center thereof, which are arranged clockwise starting from the position above the object pixel, correspond to x-0-x-x-1x-1-x (where x is don't care).

33. The thinning system of claim 20, wherein the post processing thins two-pixel thickness of the object pixel into one-pixel thickness when eight neighborhood pixels p2, p3, p4, p5, p6, p7, p8 and p9 of a 3×3 window pattern including the object pixel P at the center thereof, which are arranged clockwise starting from the position above the object pixel, correspond to 1-x-x-0-x x-1-x (where x is don't care).

34. A computer program product for thinning an image, the computer program product comprising computer program code embodied in a computer-readable medium, the computer program code configured to provide the image thinning system of claim 18.
